(19) United States
(12) Patent Application Publication
(10) Pub. No.: US 2006/0136696 A1
(43) Pub. Date: Jun. 22, 2006

(54) Method and apparatus for address translation

(76) Inventor: Brian C. Grayson, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/013,807

(22) Filed: Dec. 16, 2004

(51) Int. Cl. G06F 12/10

(52) U.S. Cl. 711/206; 711/216

(57) ABSTRACT

A memory management unit (MMU) has a cache for storing address translation entries (ATEs) corresponding to virtual addresses. If an ATE is present for a requested virtual address, then it is translated to the physical address and sent to main memory. If the MMU cache misses, the virtual address is hashed to obtain the physical address for a group of ATEs. After hashing, a decision is made whether to prefetch the group of ATEs or not. If so, the group is loaded into the data cache. Another determination is made; in this case whether to continue or not. If the request is not valid, the process is terminated. If the request is still valid, then a tablewalk is performed on the group to find the matching entry, which is loaded into the MMU cache. The virtual address is translated to obtain the physical address which is sent to main memory.

### FIELD OF THE INVENTION

This invention relates to processing systems and more particularly to processing systems that use address translation.

### BACKGROUND OF THE INVENTION

Processing systems commonly use a virtual addressing scheme in order to provide protection and flexibility in the use of main memory. A memory management unit (MMU) provides control of the translation from the virtual address to the physical (also called real) address used to access main memory (also called system memory). The particular way in which the virtual address is converted to a physical address varies. The particular translation being used varies with the application. One way this is handled is to have what is called a page table entry (PTE) for each translation. Thus for any given virtual address there is a corresponding PTE. Some PTEs are held in a cache portion of the MMU for quick identification of the PTE that goes with the particular virtual address. If the PTE is not present in the MMU cache, the PTE is identified through a tablewalk operation. This is achieved by obtaining from main memory a page table entry group (PTEG) that is a group, commonly 8 or 16, of PTEs. The PTEGs may be in a data cache, but that is not typically the case. The address of the PTEG is identified by an operation on the virtual address called “hashing.” Thus, the virtual address is hashed and used to obtain the physical address of the PTEG. Each PTE in the PTEG is tested in relation to the virtual address to determine if the PTE for that address is present. If there is no match to any of the PTEs in the PTEG, either an exception is initiated or a secondary PTEG is then obtained from main memory and the PTEs of the secondary PTEG are compared to the virtual address.

The MMU cache is generally in two portions, L1 and L2, and intentionally small in order to provide fast access. A hit in the L1 MMU cache typically takes on the order of 3 cycles, while a hit in the L2 MMU cache, which is larger than L1, takes on the order of 12 cycles. When there is a miss in the MMU cache for the virtual address, there is then a comparatively lengthy process of obtaining the PTEGs and performing the table lookup. This can easily take 100 cycles. One approach has been to immediately begin to execute the table walk after determining there is a miss in the MMU cache. One difficulty with this approach is that the lookup operation is performed, causing a portion of the MMU cache to be overwritten even if request for the data at the virtual address turns out to be in error. Overwriting any portion of the MMU cache with a location that is not going to be used increases the risk of a subsequent miss in the MMU cache, which is a penalty of over 100 cycles.

Thus there is a need for address translation that overcomes or reduces one or more of the issues raised above.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the following drawings:

FIG. 1 is a block diagram of a processing system according to a first embodiment of the invention;

FIG. 2 is a block diagram of a portion of the processing system of FIG. 1 according to the first embodiment; and

FIG. 3 is a flow diagram useful in understanding the first embodiment of the invention.

### DETAILED DESCRIPTION OF THE PREFERRED EMBODIMENT

In one aspect, a processing system has a memory management unit that has a cache for storing address translation entries corresponding to virtual addresses. If the address translation entry is present for a requested virtual address, then the virtual address is translated to the physical address and sent to memory to obtain the data at that physical address. If there is a miss in the MMU cache, the virtual address is hashed to obtain the physical address for a group of address translation entries. After obtaining this hashed address, a decision is made as to whether the group of address translation entries is to be prefetched. If so, the group is loaded into the data cache. Another determination is made as to whether to continue or not. If request for data is not valid, the process is terminated. If the request for data is still valid, then a tablewalk is performed on the group of address translation entries stored in the data cache until the matching entry is found. The matching entry is loaded into the MMU cache and the virtual address is translated to obtain the physical address and that physical address is sent to main memory to obtain the data at that address. This is better understood with reference to the drawings and the following description.

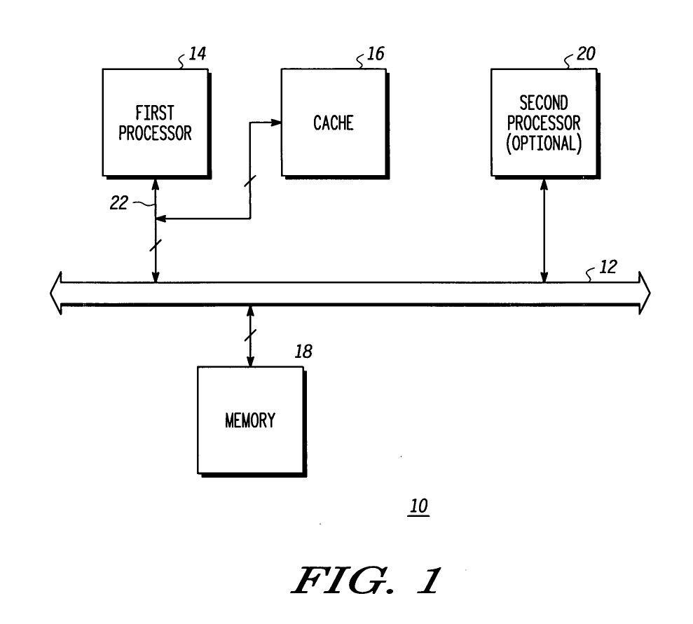

Shown in FIG. 1 is a processing system 10 having a bus 12 and a first processor 14, a data cache 16, a memory 18, and second processor 20 coupled to bus 12. This shows that more than one processor may be coupled to bus 12. Also other elements such as peripheral devices may be coupled to bus 12. In operation, first processor 14 performs operations including sending addresses onto bus 12 from an interface bus 22 and receiving data from cache 16. For cases where cache 16 does not have the data, main memory 18 provides the data and it is loaded into cache 16. In this case first processor 12 internally has virtual addresses that are converted to physical addresses.

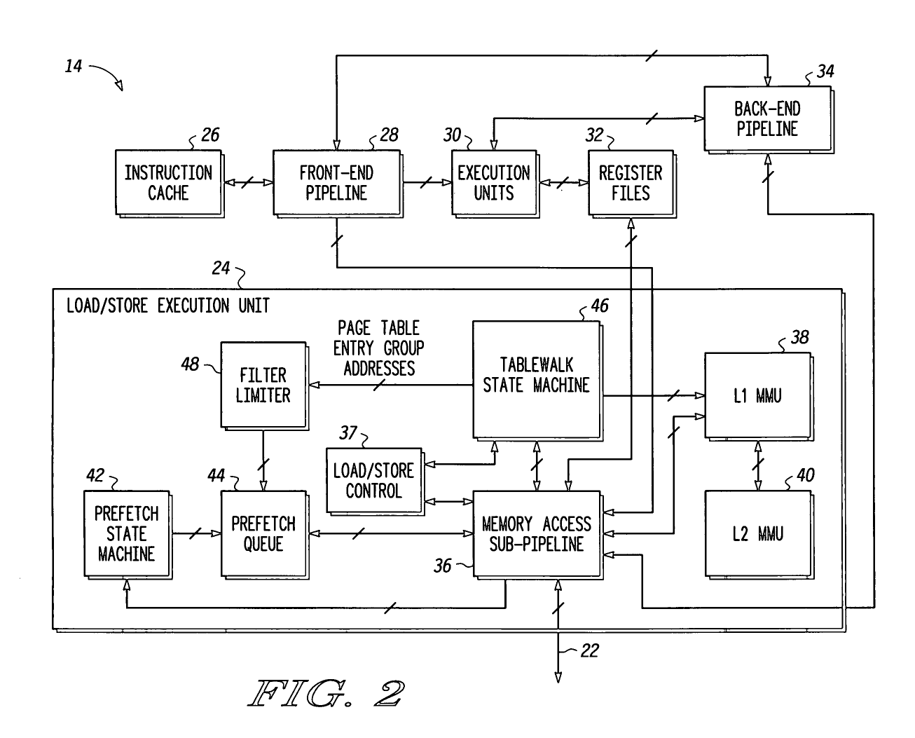

Shown in FIG. 2 is processor 14 in more detail. Processor 14 comprises a load/store execution unit 24, an instruction cache 26, a front-end pipeline 28 coupled by a two way bus to instruction cache 26, an output bus to load/store execution unit 24, execution units coupled to front-end pipeline 28 via an input bus, register files coupled to execution units 30 via a two way bus and load/store execution unit 24 by a two way bus, and a back-end pipeline 34 coupled to execution units 30 by a two way bus and load/store execution unit 24 by a two way bus. Load/store execution unit 24 comprises a memory access sub-pipeline that is coupled to interface bus 22 and to back-end pipeline 34 via the two way bus between back-end pipeline 34 and load/store execution unit 24 and to register files 32 via the two way bus between register files 32 and load/store execution unit 24, a load/store control unit 37 coupled to memory access sub-pipeline 36 by a two way bus, an L1 MMU 38 coupled to memory access sub-pipeline by an input bus, an L2 MMU 40 coupled to L1 MMU 38 by a two way bus, a prefetch bus coupled to memory access sub-pipeline by an input bus, a prefetch queue 44 coupled to prefetch state machine 42 by an input bus and coupled to memory access sub-pipeline 36 by a two way bus, a tablewalk state machine 46, and a filter limiter 48 coupled to prefetch queue by an output bus and tablewalk state machine 46 by an input bus. Tablewalk state machine 46 is coupled to memory access sub-pipeline via a two way bus, to load/store control 37 via a two way bus, to L1 MMU 38 via an output bus, and to filter limiter 48 by an output bus.

In operation, processor 14 functions according to instructions from instruction cache 26 under the control of execution units 30. As is known for processor systems, the front-end pipeline works in conjunction with the execution units in preparation for operations and back-end pipeline 34 similarly works in conjunction with the execution units 30 for handling results from the operations. The combination of front-end pipeline 28, execution units 30, back-end pipeline 34, and memory access sub-pipeline can be considered an instruction pipeline that buffers and executes data processing instructions.

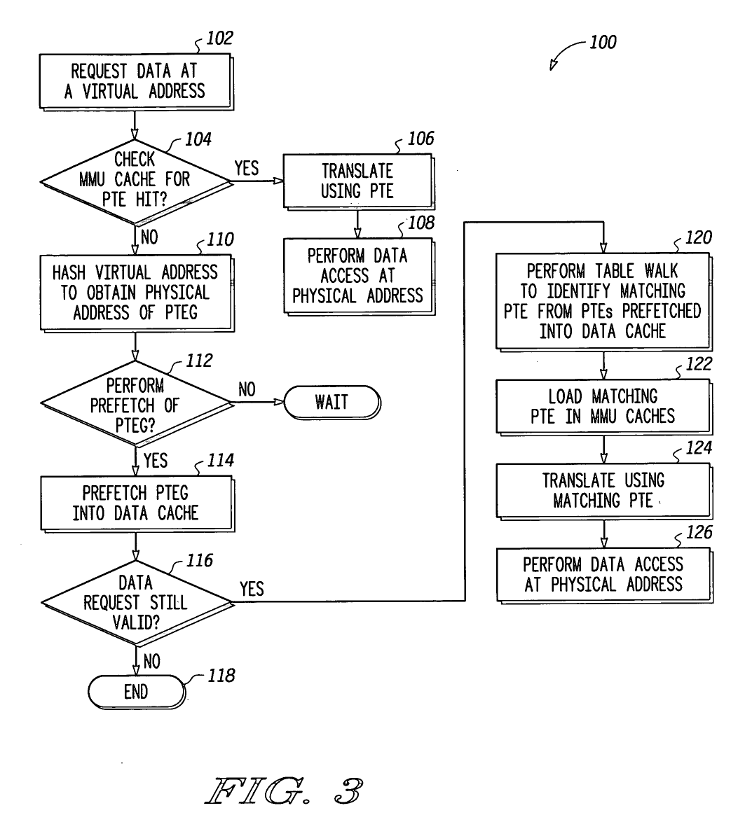

A method 100, which is comprised of steps 102, 104, 106, 108, 110, 112, 114, 116, 118, 120, 122, 124, and 126, of operating processor 14 is shown in FIG. 3. In the case of execution units 30 needing to obtain the data at a virtual address, which corresponds to step 102, memory access sub-pipeline receives the virtual address and submits it to L1 MMU 38 which determines if a page table entry (PTE) is present for the virtual address. This corresponds to step 104. Page table entries (PTEs) are a common type of address translation entry and generally preferred. This will generally take about 3 cycles of the clock. If the corresponding PTE is present in L1 MMU 38, the corresponding PTE is used by load/store control 37 to generate the physical address. This corresponds to step 106. The physical address is then put onto interface bus 22 via memory access sub-pipeline 22 which corresponds to step 108. This is conventional operation. If the corresponding PTE is present in L2 MMU, then it takes about another 9 cycles to identify the corresponding PTE. Similarly, the corresponding PTE is used to generate the physical address which is then put onto the interface bus 22.

For the case in which the MMU cache does not have the corresponding PTE, which in this example means that the corresponding PTE is present in neither L1 MMU 38 nor L2 MMU 40, then the virtual address is hashed to obtain the physical address for a group of PTEs from which the corresponding PTE may be found. The group may itself comprise groups. A group of PTEs is called a page table entry group (PTEG). Rather than automatically proceeding with prefetching the PTEG from the physical address that was obtained by hashing, there is a decision to proceed or not, which corresponds to step 112. This decision is made by the filter limiter and is based on factors such as how speculative is the prefetch and how many PTEG fetches are pending. A prefetch of a PTEG will result in data cache 16 being loaded and that may be undesirable to alter the cache if the prefetch is highly speculative.

If the decision is to wait, then other operations will continue without prefetching the PTEG. If the decision is to move forward with the prefetching of the PTEG, then that request is loaded into prefetch queue 44. This decision is made prior to the opportunity to load the prefetch queue so that there is no delay in loading prefetch queue if the decision is to do so. Upon a miss in the MMU cache, memory access pipeline 36 will be flushed. The loading of prefetch queue 44 can occur prior to this flushing being completed. Prefetch queue is used for storing prefetch requests of data and instructions from execution units 30, which is known to one of ordinary skill in the art. The additional use of prefetch queue 44 for PTEG prefetches is, however, beneficial because it does not automatically result in the overwriting of data cache 16 and L1 MMU 38 and L2 MMU 40. Under the control of prefetch queue 44, the PTEG is obtained by putting the physical address thereof out on interface bus 22, which corresponds to step 114.

After receiving the PTEG, a determination of the validity of the request for the virtual address is made, which corresponds to step 116. This decision point is also advantageous because if the data request is not valid, the writing of L1 MMU and L2 MMU can be avoided. If the data request is no longer valid, the operation is ended, which corresponds to step 118.

If the data request is still valid, then the table walk of the PTEG is performed, which corresponds to step 120, to obtain the corresponding PTE. This may involve tablewalking through more than one group. Also, the acquisition of the PTEG has been characterized as requiring a single physical address, but there may be a requirement for one or more additional physical addresses to obtain the complete PTEG. This possibility of more than one group of PTEs is known to one of ordinary skill in the art. The tablewalking is performed by tablewalk state machine 46.

After the corresponding PTE has been found, it is loaded into the MMU cache which in this case is both L1 MMU 38 and L2 MMU 40. This corresponds to step 122. The corresponding PTE is then used by the load/store control to convert the virtual address to the physical address, which corresponds to step 124. The physical address is then put onto interface bus 22 via memory access sub-pipeline 36 to obtain the requested data from memory, either main memory 18 or cache 16.

Various changes and modifications to the embodiments herein chosen for purposes of illustration will readily occur to those skilled in the art. For example, other MMU arrangements for the MMU cache could be used. Prefetching PTEGs could be performed for misses in the instruction MMU as well as the data MMU. Different filtering criteria could be used to decide whether or not to proceed with a prefetch of the PTEG. The arrangement of the PTEs within PTEGs could be altered. The tablewalk could be performed by software instead of hardware. To the extent that such modifications and variations do not depart from the spirit of the invention, they are intended to be included within the scope thereof which is assessed only by a fair interpretation of the following claims.

1. Apparatus for translating memory addresses, comprising:
an instruction cache for providing data processing instructions;
an instruction pipeline coupled to the instruction cache for buffering and executing the data processing instructions and comprising at least a memory access sub-pipeline;
a control unit coupled to the instruction cache for executing memory access instructions within the data processing instructions;
a memory management unit cache coupled to the control unit for selectively providing a translated memory address entry to the control unit in response to being accessed by the control unit with a virtual address;
a state machine coupled to the control unit, the state machine being accessed by the control unit when the memory management unit cache does not contain the translated memory address entry, the state machine providing one or more addresses defining possible locations of a desired address translation entry;
a prefetch queue coupled to the state machine for holding prefetch requests, the prefetch queue receiving the possible locations of the desired address translation entry and being coupled to the control unit for providing a prefetch request of the desired address translation entry in response to detecting a speculative address translation miss;
a data cache coupled to the control unit, the data cache selectively storing data corresponding to memory addresses; and
a main memory coupled to the control unit and the data cache, the control unit determining whether data corresponding to the possible locations of the desired address translation entry is resident in the data cache, and if not, obtaining data corresponding to the possible locations of the desired address translation entry, and loading the data to the data cache;
wherein the data is searched by the control unit for a match with the desired address translation entry, and upon detection of the match the desired address translation entry is loaded into the memory management unit cache.

2. The apparatus of claim 1 wherein the prefetch queue processes prefetch requests of explicit software-directed prefetch requests, hardware-generated prefetch requests and address translation entry prefetch requests.

3. The apparatus of claim 1 further comprising:
a circuit coupled between the state machine and the prefetch queue, the circuit eliminating a portion of received locations of desired address translation entries and not providing prefetch requests in response thereto.

4. The apparatus of claim 1 further comprising:
a circuit coupled between the state machine and the prefetch queue, the circuit delaying prefetching of the location of the desired address translation entry for a predetermined number of data processing cycles.

5. The apparatus of claim 1 further comprising:
a circuit coupled between the state machine and the prefetch queue, the circuit eliminating a portion of received locations of desired address translation entries and not providing prefetch requests in response thereto, and the circuit also delaying prefetching of the location of the desired address translation entry for a predetermined number of data processing cycles.

6. The apparatus of claim 1 wherein the memory management unit cache further comprises a level one cache coupled to the control unit and a level two cache coupled to the level one cache.

7. The apparatus of claim 1 wherein the address translation entry comprises a memory page table entry.

8. The apparatus of claim 1 wherein the state machine further comprises circuitry for implementing a hashing function on the virtual address.

9. A method for translating a memory address comprising:
requesting data at a virtual address;
checking a memory management unit cache for presence of an address translation entry hit indicating that the virtual address is in the memory management unit cache and providing an address translation entry from the memory management unit cache;
translating the virtual address to a physical address using the address translation entry if there is a hit and performing a data access at the physical address;
when no hit occurs, hashing the virtual address to obtain one or more possible physical addresses of the address translation entry;
performing a prefetch of the one or more physical addresses from a main memory into a data cache;
determining if the address translation entry is still required;
if the address translation entry is still required, peforming a tablewalk to search for a matching address translation entry from the one or more physical addresses prefetched from the main memory into the data cache;
loading the matching address translation entry into the memory management unit cache;
translating the virtual address to a corresponding physical address using the matching address translation entry; and
performing a data access at the corresponding physical address.

10. The method of claim 9 further comprising:
implementing the memory management unit cache with a level one cache and a level two cache.

11. The method of claim 9 further comprising:
prior to performing the tablewalk, determining that an incorrectly speculated instruction execution occurred; and
terminating memory address translation in response to the incorrectly speculated instruction execution.

12. The method of claim 9 further comprising:
using a same prefetch queue to perform the prefetch of the one or more physical addresses from a main memory into a data cache as used to perform instruction and data prefetches in a system translating the memory address.

13. The method of claim 9 further comprising:
eliminating a predetermined number of the one or more physical addresses of the address translation entry and not providing prefetch requests in response thereto.

14. The method of claim 9 further comprising:
delaying the providing of prefetch requests for a predetermined number of data processing cycles to allow a portion which is less than all of pending speculative decisions to be resolved.

15. A method for translating memory addresses, comprising:
providing data processing instructions from an instruction cache;
buffering and executing the data processing instructions with at least a memory access sub-pipeline;
executing memory access instructions in the memory access sub-pipeline, the memory access instructions being contained within the data processing instructions;
selectively providing a translated memory address entry in response to receiving a virtual address;
when the translated memory address entry is not stored within a memory management unit cache, providing one or more addresses defining possible locations of a desired address translation entry;
holding prefetch requests in a prefetch queue, the prefetch queue receiving the possible locations of the desired address translation entry and providing a prefetch request of the desired address translation entry in response to detecting a speculative address translation miss and prior to flushing the memory access sub-pipeline;
selectively storing data corresponding to physical memory addresses in a data cache and storing all data corresponding to physical memory addresses in a main memory; and
determining whether data corresponding to the possible locations of the desired address translation entry is resident in the data cache, and if not, obtaining data corresponding to the possible locations of the desired address translation entry from the main memory, and loading the data to the data cache;
wherein the data is searched for a match with the desired address translation entry, and upon detection of the match the desired address translation entry is loaded into the memory management unit cache.

16. The method of claim 15 further comprising:
processing from the prefetch queue explicit software-directed prefetch requests, hardware-generated prefetch requests and address translation entry prefetch requests.

17. The method of claim 15 further comprising:
eliminating a portion of received locations of desired address translation entries and not providing prefetch requests in response thereto.

18. The method of claim 15 further comprising:
delaying prefetching of the location of the desired address translation entry for a predetermined number of data processing cycles.

19. The method of claim 15 further comprising:
eliminating a portion of received locations of desired address translation entries and not providing prefetch requests in response thereto; and
delaying prefetching of the location of the desired address translation entry for a predetermined number of data processing cycles.

20. The method of claim 15 further comprising:
implementing a hashing function on the virtual address.
